(19) United States
(12) Patent Application Publication
(10) Pub. No.: US 2002/0145508 A1
(43) Pub. Date: Oct. 10, 2002

(54) Pace setting device

(76) Inventors: James Skeen, Tehachapi, CA (US); Susan Skeen, Tehachapi, CA (US)

Correspondence Address: Richard W. Goldstein, 2071 Clove Road, Staten Island, NY, 10304, US

(21) Appl. No.: 09/829,271

(22) Filed: Apr. 9, 2001

(51) Int. Cl. G08B 1/00

(52) U.S. Cl. 340/309.15; 340/309.3; 340/573.1; 340/384.71

(57) ABSTRACT

A pace setting device including a central unit having an internal processor capable of generating an adjustable pulsed signal. The central unit includes a power source. A speaker is provided that is in communication with the internal processor of the central unit to allow the user to hear the pulsed signal. The speaker is positionable with respect to an ear of a user.

### BACKGROUND OF THE INVENTION

The present invention relates to a pace setting device and more particularly pertains to providing a reference for maintaining a predetermined pace in a repetitive activity.

The use of electronic devices is known in the prior art. More specifically, electronic devices heretofore devised and utilized for the purpose of communicating to users are known to consist basically of familiar, expected and obvious structural configurations, notwithstanding the myriad of designs encompassed by the crowded prior art which have been developed for the fulfillment of countless objectives and requirements.

By way of example, U.S. Pat. No. 4,926,879 to Sevrain discloses a wrist-worn device capable of electrically stimulating the skin in response to a signal. U.S. Pat. Nos. 4,225,965 to Baugh and 5,663,703 to Pearlman disclose wrist worn communications systems capable of providing a silent alarm to the user. U.S. Pat. No. 5,686,882 to Giani discloses an additional silent alarm band.

While these devices fulfill their respective, particular objective and requirements, the aforementioned patents do not describe a pace setting device for providing a reference for maintaining a predetermined pace in a repetitive activity.

In this respect, the pace setting device according to the present invention substantially departs from the conventional concepts and designs of the prior art, and in doing so provides an apparatus primarily developed for the purpose of providing a reference for maintaining a predetermined pace in a repetitive activity.

Therefore, it can be appreciated that there exists a continuing need for a new and improved pace setting device which can be used for providing a reference for maintaining a predetermined pace in a repetitive activity. In this regard, the present invention substantially fulfills this need.

### SUMMARY OF THE INVENTION

In the view of the foregoing disadvantages inherent in the known types of electronic devices now present in the prior art, the present invention provides an improved pace setting device. As such, the general purpose of the present invention, which will be described subsequently in greater detail, is to provide a new and improved pace setting device which has all the advantages of the prior art and none of the disadvantages.

To attain this, the present invention essentially comprises a head band adapted for being positioned on a head of a user. The head band consists of a flexible inverted U-shaped member having opposed free ends. The flexible inverted U-shaped member is positionable on the head of the user whereby the opposed free ends are disposed adjacent to ears of the user. A central unit is secured to the head band. The central unit includes an internal processor capable of generating an adjustable pulsed signal. The central unit includes a power source. The power source consists of a plurality of solar panels. The central unit includes a power switch. The internal processor includes a display for displaying a selected frequency of the pulsed signal. The internal processor includes adjustment controls for adjusting the selected frequency. A speaker is secured to one of the opposed free ends of the flexible inverted U-shaped member of the head band. The speaker is in communication with the internal processor of the central unit to allow the user to hear the pulsed signal.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new and improved pace setting device which has all the advantages of the prior art electronic devices and none of the disadvantages.

It is another object of the present invention to provide a new and improved pace setting device which may be easily and efficiently manufactured and marketed.

It is a further object of the present invention to provide a new and improved pace setting device which is of durable and reliable construction.

An even further object of the present invention is to provide a new and improved pace setting device which is susceptible of a low cost of manufacture with regard to both materials and labor, and which accordingly is then susceptible of low prices of sale to the consuming public, thereby making such a pace setting device economically available to the buying public.

Even still another object of the present invention is to provide a new and improved pace setting device for providing a reference for maintaining a predetermined pace in a repetitive activity.

Lastly, it is an object of the present invention to provide a new and improved pace setting device including a central unit including an internal processor capable of generating an adjustable pulsed signal. The central unit includes a power source. A speaker is provided that is in communication with the internal processor of the central unit to allow the user to hear the pulsed signal. The speaker is positionable with respect to an ear of a user.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a perspective view of the preferred embodiment of the pace setting device constructed in accordance with the principles of the present invention.

FIG. 2 is a perspective view of the central unit of the present invention.

The same reference numerals refer to the same parts through the various figures.

### DESCRIPTION OF THE PREFERRED EMBODIMENT

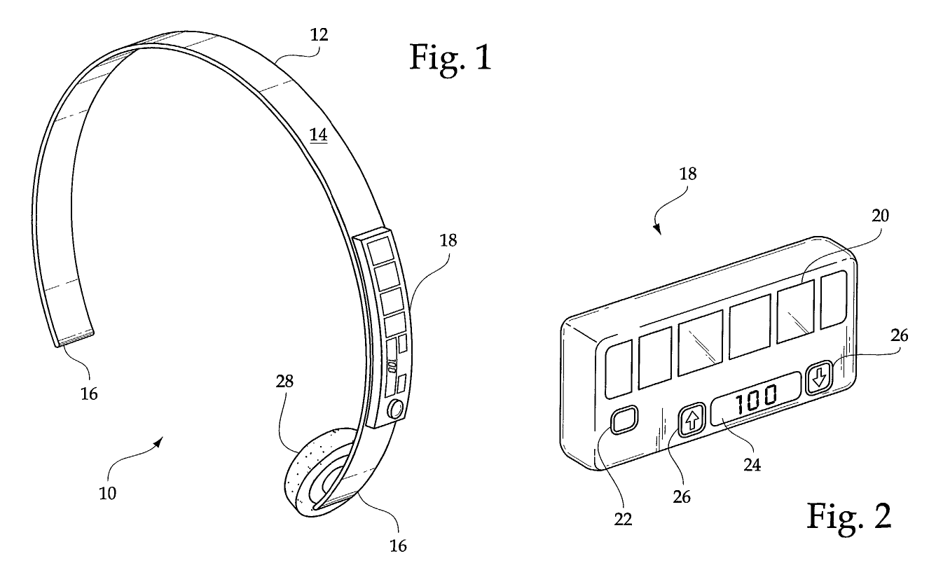

With reference now to the drawings, and in particular, to FIGS. 1 through two thereof, the preferred embodiment of the new and improved pace setting device embodying the principles and concepts of the present invention and generally designated by the reference number 10 will be described.

Specifically, it will be noted in the various Figures that the device relates to a pace setting device for providing a reference for maintaining a predetermined pace in a repetitive activity. In its broadest context, the device consists of a head band, a central unit, and a speaker. Such components are individually configured and correlated with respect to each other so as to attain the desired objective.

The head band 12 is adapted for being positioned on a head of a user. The head band 12 consists of a flexible inverted U-shaped member 14 having opposed free ends 16. The flexible inverted U-shaped member 14 is positionable on the head of the user whereby the opposed free ends 16 are disposed adjacent to ears of the user.

The central unit 18 is secured to the head band 12. The central unit 18 includes an internal processor capable of generating an adjustable pulsed signal. The central unit 18 includes a power source. The power source consists of a plurality of solar panels 20. The central unit 18 includes a power switch 22. The internal processor includes a display 24 for displaying a selected frequency of the pulsed signal. The internal processor includes adjustment controls 26 for adjusting the selected frequency.

The speaker 28 is secured to one of the opposed free ends 16 of the flexible inverted U-shaped member 14 of the head band 12. The speaker 28 is in communication with the internal processor of the central unit 18 to allow the user to hear the pulsed signal.

Alternate designs of the present invention would allow the speaker 28 to be secured to the head of the user so it is positioned within the user's ear. Such a design might include a hat that will hold the speaker 28 in a position relative to the ear. Additionally, the head band 12 could be provided with an adjustable chin strap or ear hook to prevent the head band 12 from becoming disengaged from the head during use.

The present invention is designed to provide a constant frequency, pulsed signal as a reference for individuals who want to maintain a particular pace in a repetitive, rhythmic activity such as swimming or running. Similar to a metronome, both the frequency and intensity of the signal will be controllable by the user.

As to the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and the manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modification and changes will readily occur to those skilled in the art, it is not desired to limit the invention to the exact construction and operation shown and described, and accordingly, all suitable modification and equivalents may be resorted to, falling within the scope of the invention.

What is claimed as being new and desired to be protected by Letters Patent of the United States is as follows:

1. A pace setting device for providing a reference for maintaining a predetermined pace in a repetitive activity comprising, in combination:
a head band adapted for being positioned on a head of a user, the head band being comprised of a flexible inverted U-shaped member having opposed free ends, the flexible inverted U-shaped member being positionable on the head of the user whereby the opposed free ends are disposed adjacent to ears of the user;
a central unit secured to the head band, the central unit including an internal processor capable of generating an adjustable pulsed signal, the central unit including a power source, the power source being comprised of a plurality of solar panels, the central unit including a power switch, the internal processor including a display for displaying a selected frequency of the pulsed signal, the internal processor including adjustment controls for adjusting the selected frequency; and
a speaker secured to one of the opposed free ends of the flexible inverted U-shaped member of the head band, the speaker being in communication with the internal processor of the central unit to allow the user to hear the pulsed signal.

2. A pace setting device for providing a reference for maintaining a predetermined pace in a repetitive activity comprising, in combination:
a central unit including an internal processor capable of generating an adjustable pulsed signal, the central unit including a power source; and
a speaker being in communication with the internal processor of the central unit to allow the user to hear the pulsed signal, the speaker being positionable with respect to an ear of a user.

3. The pace setting device as set forth in claim two, and further including a head band adapted for being positioned on a head of a user, the head band being comprised of a flexible inverted U-shaped member having opposed free ends, the flexible inverted U-shaped member being positionable on the head of the user whereby the opposed free ends are disposed adjacent to ears of the user, one of the opposed free ends having the speaker secured thereto.

4. The pace setting device as set forth in claim two, wherein the power source of the internal processor of the central unit consists of a plurality of solar panels.

5. The pace setting device as set forth in claim two, wherein the central unit includes a power switch.

6. The pace setting device as set forth in claim two, wherein the internal processor includes a display for displaying a selected frequency of the pulsed signal.

7. The pace setting device as set forth in claim six, wherein the internal processor includes adjustment controls for adjusting the selected frequency.
